(19) United States
(12) Patent Application Publication
(10) Pub. No.: US 2021/0299757 A1
(43) Pub. Date: Sep. 30, 2021

(54) CLAMPING BLOCK FOR RECEIVING A PARTING BLADE

(71) Applicant: CERATIZIT AUSTRIA GESELLSCHAFT M.B.H., Reutte (AT)

(72) Inventors: CHRISTIAN GOEBERL, REUTTE (AT); UWE SCHLEINKOFER, REUTTE (AT)

(21) Appl. No.: 16/614,953

(22) PCT Filed: Apr. 19, 2018
(86) PCT No.: PCT/AT2018/000027

§ 371 Date: Nov. 19, 2019

(30) Foreign Application Priority Data
May 19, 2017 (AT) GM 115/2017

(51) Int. Cl. B23B 27/10; B23B 29/04; B23B 27/08

(52) U.S. Cl. CPC B23B 27/10; B23B 27/086; B23B 29/043

(57) ABSTRACT

A clamping block receives a parting blade having an internal coolant guide. The clamping block includes a parting blade seat having a contact face for a lateral face of the parting blade. The parting blade may be received in a first installation direction and in a second installation direction. A first coolant exit opening for transferring coolant into the parting blade in the first installation direction, and a second coolant exit opening for transferring coolant into the parting blade in the second installation direction, are configured on the contact face. A first internal coolant duct structure connects the first coolant exit opening so as to communicate with at least two different first coolant entry openings, and a second internal coolant duct structure connects the second coolant exit opening so as to communicate with at least two different second coolant entry openings.

The present invention relates to a clamping block for receiving a parting blade having an internal coolant guide.

Parting blades (in some instances also referred to as parting knives), are often used in the subtractive machining by grooving or parting, said parting blades having a plate-type elongate shape having two large lateral faces, two long longitudinal edges that serve as a chucking portion, and two shorter end-side transverse edges. A cutter portion having a seat for a replaceable cutting insert is configured at least on one corner of the parting blade, said corner being situated between one of the long longitudinal edges and one of the end-side transverse edges; in many cases there is also a further seat for a replaceable cutter insert on an opposite edge in relation to the other end-side transverse edge.

Coolant is often applied when using parting blades of this type, wherein—apart from a separate infeed of the coolant into the cutter portion outside the parting blades—an internal coolant guide through the parting blade up to the cutter portion is increasingly being used.

EP 2 822 720 B1 describes a parting blade and a corresponding clamping block which are conceived for the infeed of coolant into the cutter portion of the parting blade by way of an internal coolant infeed through the parting blade. The transfer of the coolant to the internal coolant infeed in the parting blade takes place by way of a coolant exit opening in the contact face of the clamping block on which the parting blade bears by way of one of the lateral faces thereof. The clamping block has an internal coolant duct structure which extends from a coolant entry opening of the holder to the coolant exit opening. The coolant entry opening of the holder is disposed on the lower side of the clamping block and is configured to be connected to a coolant hose.

It is an object of the present invention to provide an improved clamping block for receiving a parting blade having an internal coolant infeed, said improved clamping block being in particular capable of being used universally in the most varied installation situations and in different machine-side mountings for the clamping block.

The object is achieved by a clamping block for receiving a parting blade having an internal coolant infeed as claimed in claim 1. Advantageous refinements are derived from the dependent claims.

The clamping block has a parting blade seat having a contact face for a lateral face of the parting blade, and clamping jaws which for chucking the parting blade on the clamping block extend on opposite longitudinal sides of the contact face. The clamping block is configured for receiving the parting blade in a first installation direction in which the parting blade by way of a cutter portion projects from a first end side of the clamping block, and in the second installation direction in which the parting blade by way of the cutter portion projects from a second end side of the clamping block that is opposite the first end side. A first coolant exit opening for transferring coolant from the clamping block into the parting blade when installing in the first installation direction, and a second coolant exit opening for transferring coolant from the clamping block into the parting blade when installing in the second installation direction, are configured on the contact face. The first internal coolant duct structure by way of which the first coolant exit opening is connectable so as to communicate with at least two different first coolant entry openings of the clamping block is configured in the clamping block. A second internal coolant duct structure by way of which the second coolant exit opening is connectable so as to communicate with at least two different second coolant entry openings of the clamping block is furthermore configured in the clamping block.

A communicating connection is presently understood to be the configuring of a continuous flow path for the coolant such that connectable so as to communicate with is to be understood in such a manner that a continuous flow path from the various coolant entry openings to the respective coolant exit opening can be configured through the interior of the clamping block.

Since the clamping block is conceived for receiving the parting blade in the first installation direction and in the second installation direction, different installation positions for machining are already enabled, in which installation positions coolant from the clamping block can be transferred into the parting blade in each case by way of the first coolant exit opening, or the second coolant exit opening, respectively. Since the first internal coolant duct structure is configured in such a manner that the first coolant exit opening is connectable so as to communicate with at least two different first coolant entry openings of the clamping block, and the second internal coolant duct structure is configured in such a manner that the second coolant exit opening is likewise connectable so as to communicate with at least two different second coolant entry openings of the clamping block, a suitable one of the first or of the second coolant entry openings, respectively, of the clamping block can furthermore be utilized for infeeding coolant in each of said installation positions, depending on the spatial circumstances of the installation situation. The different first coolant entry openings can preferably be situated on different sides of the clamping block. The different second coolant entry openings can preferably also be situated on different sides of the clamping block. In one particularly advantageous implementation, coolant entry openings that are not required in the specific installation situation can in each case be closed in a fluid-tight manner, for example by covering, screw-fitting, or similar.

According to one refinement, the first internal coolant duct structure is configured in such a manner that the first coolant exit opening is connectable to at least three different first coolant entry openings of the clamping block, and the second internal coolant duct structure is configured in such a manner that the second coolant exit opening is connectable to at least three different second coolant entry openings of the clamping block. In this case, the clamping block can be used even more universally in different installation situations. In this case too, at least two of the first coolant entry openings can preferably be situated on different sides of the clamping block, and at least two of the second coolant entry openings can be situated on different sides of the clamping block.

According to one refinement, the first internal coolant duct structure and the second internal coolant duct structure are configured so as to be separate from one another. In other words, the first internal coolant duct structure and the second internal coolant duct structure are configured so as to be separate from one another in the clamping block in such a manner that there is no continuous flow path for coolant between the first internal coolant duct structure and the second internal coolant duct structure in the clamping block. This enables a simple universal application potential of the clamping block where a large number of potential flow paths for coolant not required in the specific installation situation do not have to in each case be closed.

According to one refinement, the first coolant entry openings have a coolant entry opening on the second end side of the clamping block. In this case, the infeeding of the coolant to the clamping block can in particular also take place on the end side of the clamping block that faces away from the cutter portion that is currently in use. This is advantageous when said coolant entry opening is accessible in the specific installation situation. The coolant entry opening on the second end side can preferably be configured for connecting a coolant hose. The potential for connecting a coolant hose is advantageous because a design embodiment of the machine-side mounting for the clamping block that is especially adapted to the coolant supply is not required in this case. The coolant entry opening is preferably configured so as to be closable in a reversible manner such that said coolant entry opening is capable of being closed by means of a screw or similar, for example, and can be released again when required.

According to one refinement, the second coolant entry openings have a coolant entry opening on the first end side of the clamping block. In this case, the infeeding of the coolant to the clamping block can also take place on the end side of the clamping block that faces away from the cutter portion that is currently in use even when the parting blade is installed in the second installation direction. This is advantageous when said coolant entry opening is accessible in the specific installation situation. The coolant entry opening on the first end side can preferably be configured for connecting a coolant hose.

According to one refinement, the first coolant entry openings have a coolant entry opening for connecting a coolant hose on a lower side of the clamping block. In this case, infeeding of coolant to the clamping block by way of a coolant hose can also take place in installation situations in which the second end side of the clamping block is not accessible, for example. This coolant entry opening is also preferably closable in a reversible manner.

According to one refinement, the second coolant entry openings have a coolant entry opening for connecting a coolant hose on a lower side of the clamping block. In this case, infeeding of coolant to the clamping block by way of a coolant hose can take place even when the parting blade is installed in the second installation direction and even when the first end side of the clamping block is not accessible in the specific installation situation, for example.

According to one refinement, the clamping block has a chucking portion for chucking in a machine-side mounting for the clamping block, and the first coolant entry openings for transferring coolant directly from a coolant transfer opening in the mounting to the clamping block have a coolant entry opening that is configured on a lower side of the chucking portion. In this case, a transfer of coolant into the clamping block can take place also without utilizing separate coolant hoses when the clamping block is used in a machine-side mounting which is conceived for a direct transfer of coolant.

According to one refinement, the clamping block has a chucking portion for chucking in a machine-side mounting for the clamping block, and the second coolant entry openings for transferring coolant directly from a coolant transfer opening in the mounting to the clamping block have a coolant entry opening that is configured on the lower side of the chucking portion. In this case, when a correspondingly conceived machine-side mounting for the clamping block is used, a transfer of coolant can also take place in the second installation direction of the parting blade without additional coolant hoses being required.

According to one refinement, the coolant entry opening that is configured on the lower side of the chucking portion is configured so as to be elongate. In this case, a reliable direct transfer of coolant from the machine-side mounting into the clamping block can take place also for different relative positionings between the machine-side mounting and the clamping block in the longitudinal direction. Furthermore, this design embodiment enables the direct transfer of coolant from the machine-side mounting to the clamping block to be utilized also in the case of different commercially available machine-side mountings in which the coolant transfer openings in the mounting are dissimilarly configured. The coolant entry opening on the lower side of the chucking portion that is configured so as to be elongate herein can be configured in the form of a reservoir chamber. A longitudinal axis of the longitudinal extent preferably runs in the direction from the first end side to the second end side of the clamping block.

According to one refinement, the coolant entry opening that is configured on the lower side of the chucking portion is surrounded by an encircling groove in which an elastic sealing element is disposed. In this case, a reliable direct transfer of coolant from the machine-side mounting to the clamping block without the risk of a leakage of coolant is ensured even in the case of high coolant pressures being used.

According to one refinement, the first coolant entry opening is configured so as to be elongate. In this case too, the longitudinal extent is preferably in the direction from the first end side to the second end side of the clamping block. This design embodiment enables a reliable transfer of coolant into the parting blade for different relative positionings between the clamping blade and the clamping block such that there is an adjustability in terms of the length by way of which the parting blade projects from the clamping block. The second coolant exit opening can preferably be configured so as to be correspondingly elongate.

According to one refinement, the first coolant exit opening is surrounded by an encircling groove in which an elastic sealing element is disposed. In this case, a reliable transfer of coolant from the clamping block to the parting blade is also provided even in the case of a high coolant pressure. The second coolant exit opening can preferably also be surrounded by an encircling groove in which an elastic sealing element is disposed.

A first clamping jaw of the clamping jaws for chucking the parting blades can preferably be configured so as to be integral and fixed to that region of the clamping block that has the blade contact face, and a second clamping jaw of the clamping jaws can be configured so as to be movable relative to the first clamping jaw, this enabling a particularly reliable and safe clamping of the parting blade. The second clamping jaw herein can also be configured, for example, so as to be integral to the rest of the clamping block but so as to be elastically deflectable, or else be configured so as to be separate from the rest of the clamping block. In one preferred design embodiment, the first coolant exit opening and preferably also the second coolant exit opening can in each case be disposed so as to be closer to the first clamping jaw than to the second clamping jaw. In this case, particularly positive sealing of the transfer of coolant between the clamping block and the parting blade is achieved.

Further advantages and practicalities of the invention are derived by means of the description hereunder of exemplary embodiments with reference to the appended figures.

In the figures:

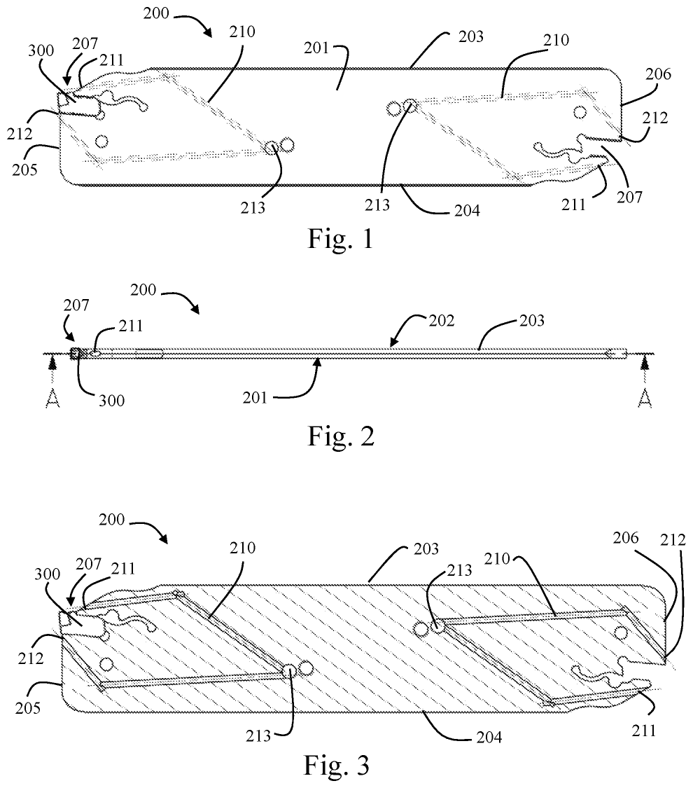

FIG. 1: shows a schematic lateral view of a parting blade having an internal coolant infeed;

FIG. 2: shows a schematic plan view of the parting blade of FIG. 1;

FIG. 3: shows a schematic sectional illustration of the parting blade along the line A-A in FIG. 2;

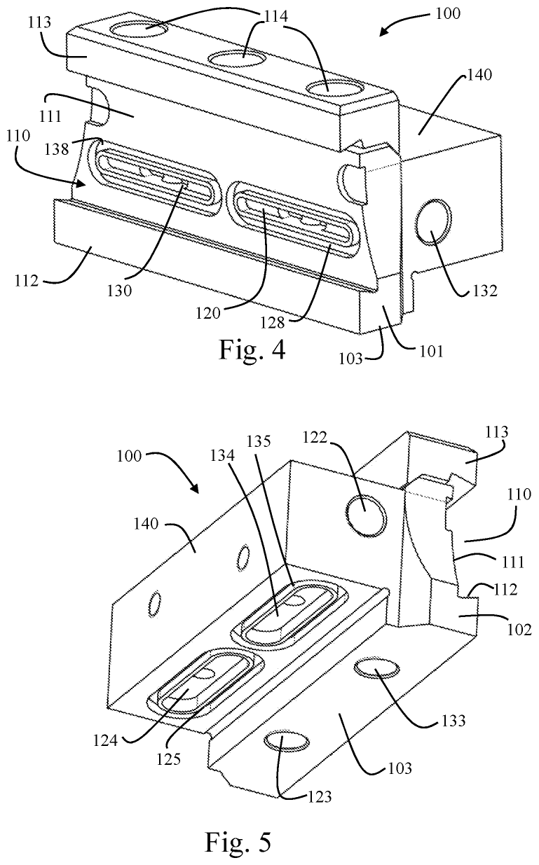

FIG. 4: shows a schematic perspective illustration of a clamping block according to one embodiment;

FIG. 5: shows a further schematic perspective illustration of the clamping block from another direction;

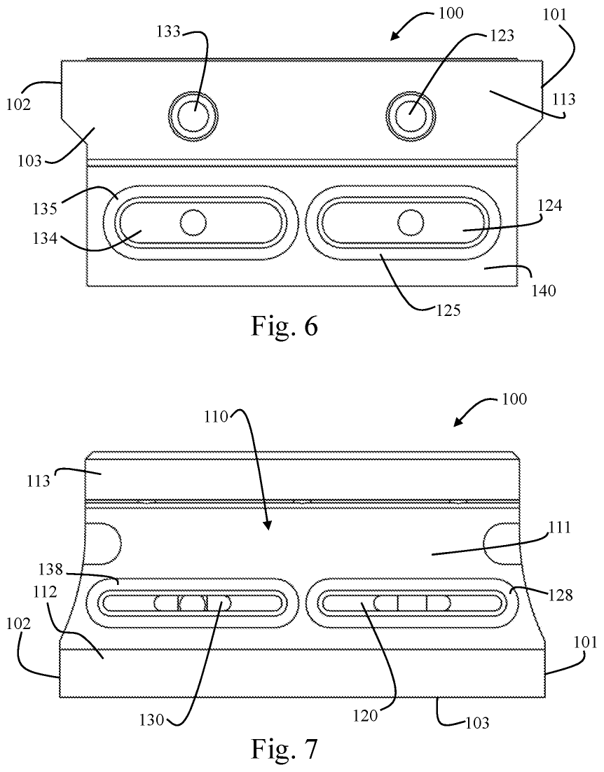

FIG. 6: shows a schematic plan view of a lower side of the clamping block;

FIG. 7: shows a schematic plan view of a contact face for receiving a parting blade at the clamping block;

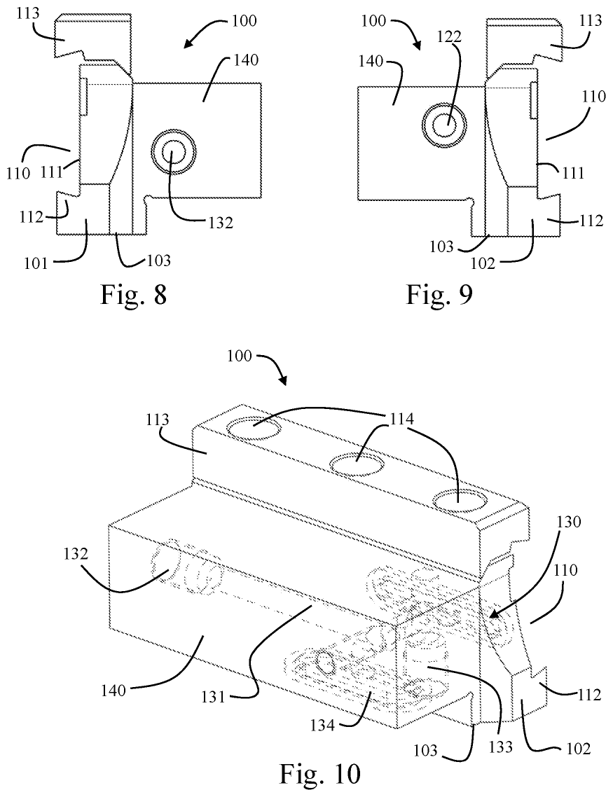

FIG. 8: shows a schematic lateral view of a first end side of the clamping block;

FIG. 9: shows a schematic lateral view of a second end side of the clamping block;

FIG. 10: shows a schematic perspective illustration of the clamping block in which a second internal coolant duct structure in the clamping block is schematically illustrated;

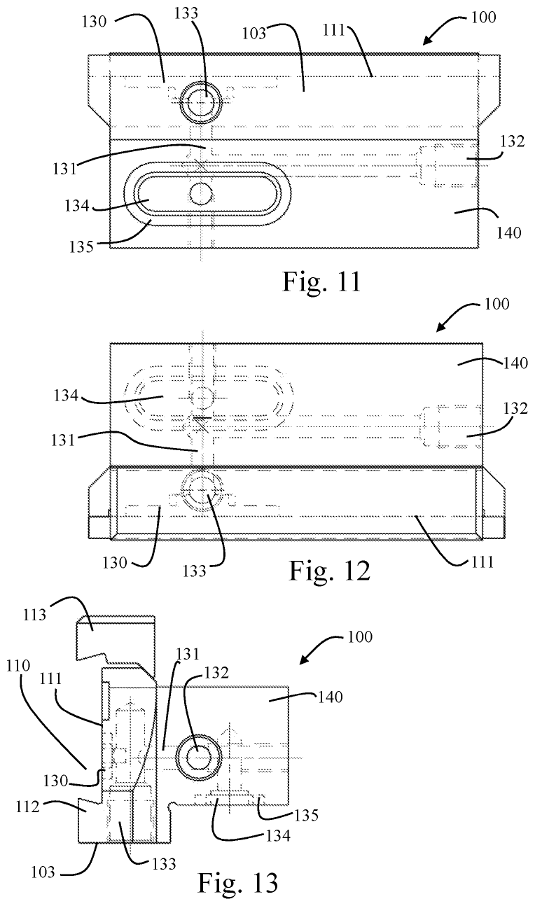

FIG. 11: shows a schematic plan view of the lower side of the clamping block in which the elements of the second internal coolant duct structure are schematically illustrated;

FIG. 12: shows a schematic plan view of the upper side of the clamping block in which the elements of the second internal coolant duct structure are schematically illustrated;

FIG. 13: shows a schematic lateral view of the first end side of the clamping block in which the elements of the second internal coolant duct structure are schematically illustrated;

FIG. 14: shows a schematic plan view of the lower side of the clamping block in which the elements of a first internal coolant duct structure are schematically illustrated;

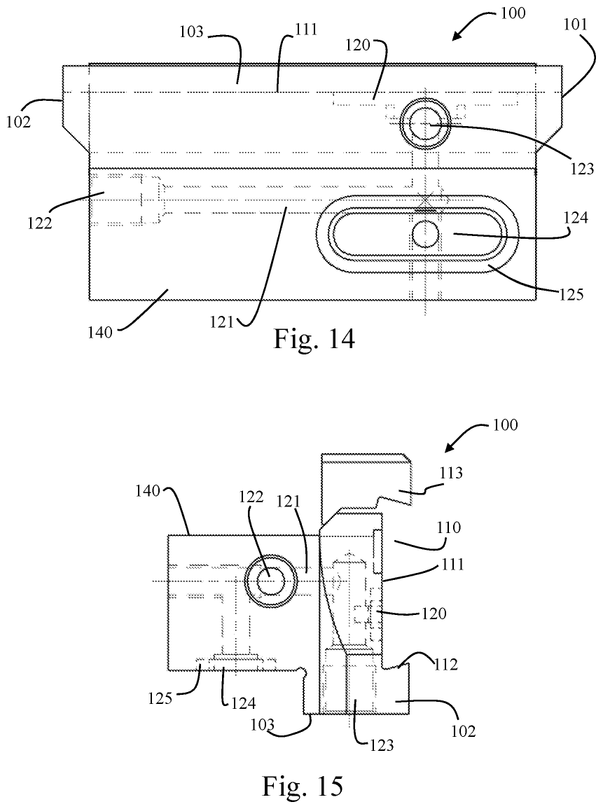

FIG. 15: shows a schematic lateral view of the second end side of the clamping block in which the elements of the first internal coolant duct structure are schematically illustrated;

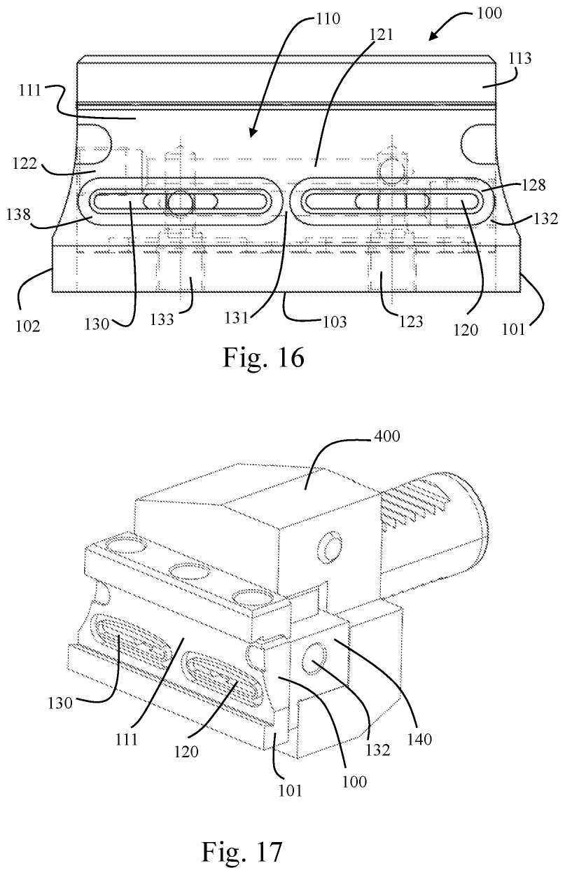

FIG. 16: shows a schematic plan view of the contact face for the parting blade at the clamping block in which the elements of the first internal coolant duct structure as well as the elements of the second internal coolant duct structure are schematically illustrated;

FIG. 17: shows a schematic illustration of the clamping block in an installed state in a machine-side mounting;

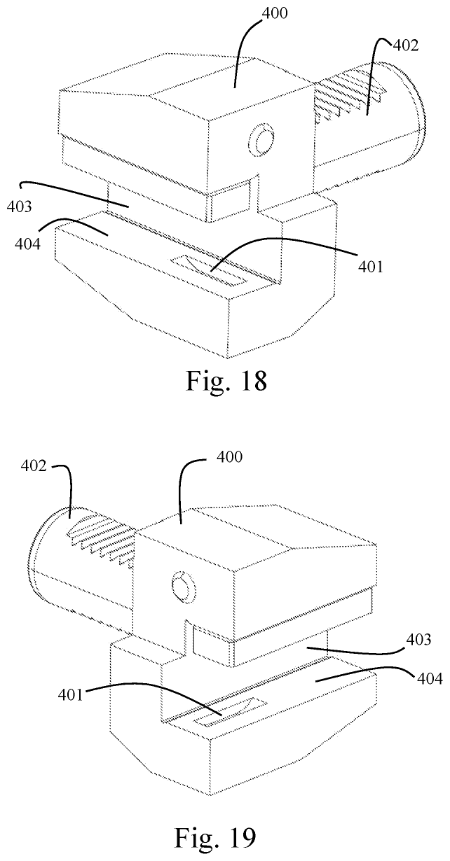

FIG. 18: shows a schematic illustration of the one machine-side mounting from FIG. 17 without an installed clamping block; and

FIG. 19: shows a schematic illustration of a machine-side mounting for an installed position that is counter to that of the machine-side mounting from FIG. 18.

An embodiment of a clamping block 100 for receiving a parting blade 200 having an internal coolant guide 210 will be described hereunder with reference to FIG. 4 to FIG. 17.

First, the design embodiment of a parting blade 200 having an internal coolant guide will be described with reference to FIG. 1 to FIG. 3, the clamping block 100 according to the embodiment being configured for receiving said parting blade 200.

The parting blade 200 in the usual manner has a plate-type elongate shape having two large lateral faces 201, 202, two long longitudinal edges 203, 204 that serve as a chucking portion, and two shorter end-side transverse edges 205, 206. A cutter portion 207 having a seat for a replaceable cutter insert 300 is configured at a corner of the parting blade 200 that is situated between a long longitudinal edge 203 and an end-side transverse edge 205. In the case of the example specifically illustrated, a further cutter portion 207 having a seat for a replaceable cutter insert is configured on an opposite edge in relation to the other end-side transverse edge 206. The long longitudinal edges 203, 204 in a thickness direction of the parting blade 200 have a roof-shaped profile, as can be seen in the illustration of FIG. 2.

As can be seen in FIG. 1 and FIG. 3, the parting blade 200 is provided with an internal coolant guide 210 by way of which coolant can be fed into the region of the cutter portion 207. In the example illustrated, the coolant guide 210 is configured for feeding coolant into the region of the rake face as well as into the region of the flank to the cutter portion 207, to which end a coolant exit 211 is provided on the rake face side and a coolant exit 212 is provided on the flank side. However, in an alternative design embodiment it is also possible for only the coolant exit 211 on the rake face side or only the coolant exit 212 on the flank side to be provided, for example.

The internal coolant guide 210 is configured by bores in the interior of the cutting blade 200. Connection bores to the longitudinal edges 203, 204 that for configuring the internal coolant guide 210 are first formed and subsequently closed again are not shown for reasons of simplification in the schematic illustration. In order for a transfer of coolant into the internal coolant guide 210 of the parting blade 200 to be enabled, one inlet opening 213 is configured in at least one of the two lateral faces 201, 202 of the parting blade 200. In the case of the example specifically illustrated, the inlet opening 213 is formed by a through bore which extends from the first lateral face 201 continuously to the second lateral face 202, and it is provided that the side of said through bore that faces away from the clamping block 100 (to be described in more detail hereunder) be closed when in operation, which can take place, for example, by way of a corresponding screw with an annular seal or similar. In the case of the embodiment illustrated, the coolant exit 211 on the rake face side and the coolant exit 212 on the flank side are both supplied with coolant by way of the same inlet opening 213 and a corresponding branching of the bores of the internal coolant guide 210. While the term bore is presently used, said bores do not mandatorily have to be configured by boring but can also be configured in the parting blade 200 by eroding, for example.

In the case illustrated in which the parting blade 200 has a further cutter portion 207, a correspondingly configured second internal coolant guide 210 for infeeding coolant to said further cutter portion 207 can be configured in the parting blade 200; this is however not mandatory.

The clamping block 100 for receiving the parting blade 200 will be described in more detail hereunder with reference to FIG. 4 to FIG. 17.

The clamping block 100 for receiving the parting blade 200 has a parting blade seat 110 on which the afore-described parting blade 200 can be chucked. The clamping block 100 on the side that faces away from the parting blade seat 110 has a chucking portion 140 for chucking the clamping block 100 in a machine-side mounting 400 which is schematically illustrated in FIG. 17, FIG. 18, and FIG. 19. The machine-side mounting 400 has a fastening interface 402 for fastening in a machine tool, and a holding portion 403 on which the clamping block 100 can be chucked. A machine-side mounting 400 for a first installation position is illustrated in FIG. 17 and FIG. 18. A machine-side mounting 400 for an installation position that is counter to the first installation position is illustrated in FIG. 19. The clamping block 100 according to the embodiment is conceived in such a manner that said clamping block 100 can be flexibly used in the machine-side mounting for the first installation position as well as in the machine-side mounting for the second installation position counter thereto.

The parting blade seat 110 in a manner known per se has a contact face 111 for one of the lateral faces 201, 202 of the parting blade 200. Clamping jaws 112, 113 for chucking the parting blade 200 along the contact face 111 extend on opposite longitudinal sides of the contact face 111, that is to say extend toward the upper side and the lower side 103 of the clamping block 100. In the case of the embodiment illustrated, a first clamping jaw 112 is embodied so as to be integral to the rest of the clamping block 200 on which the contact face 111 is configured, and a second clamping jaw 113 is embodied so as to be movable relative to the first clamping jaw 112. In the case of the embodiment, the second clamping jaw 113 can in particular be tensioned in the direction of the first clamping jaw 112 by way of a plurality of screws 114. The mutually facing clamping faces of the clamping jaws 112, 113 that are adjacent to the contact face 111 are embodied so as to be slightly oblique such that the parting blade 200 can be tensioned in the direction of the contact face 111 in that the clamping jaws 112, 113 act on the roof-shaped longitudinal sides 203, 204 of the parting blade 200.

The contact face 111 is not laterally delimited in the direction of a first end side 101 of the clamping block 100 and likewise in the direction of a second end side 102 of the clamping block 100, but said contact face 111 ends freely such that the parting blade 200 can be disposed in a first installation direction in the parting blade seat 110 in such a manner that said parting blade 200 by way of the cutter portion 207 projects from the first end side 101 of the clamping block 100, and can also be disposed in a second installation direction in the parting blade seat 110 such that said parting blade 200 by way of the cutter portion 207 projects from the second end side 102 of the clamping block 100. It has to be observed herein that the parting blade 200, depending on the specific design embodiment of the parting blade 200 and of the clamping block 100, also in the case of a disposal in the first installation direction, by way of the other transverse edge 205 which faces away from the active cutter portion 207 and on which a further cutter portion can optionally also be configured can additionally also project from the second end side 102 of the clamping block 100. The same applies in the converse manner to an installation of the parting blade 200 in the second installation direction. The parting blade seat 110 is configured in such a manner that the length by way of which the parting blade 200 projects from the clamping block 100 can be varied in that the parting blade 200 in the non-tensioned state of the clamping jaws 112, 113 can be displaced in the longitudinal direction relative to the clamping block 100.

As can in particular be seen in FIG. 4, FIG. 7, and FIG. 15 to FIG. 17, a first coolant exit opening 120 for transferring coolant to the internal coolant guide 210 of the parting blade 200 when the latter is situated in the first installation direction is provided on the contact face 111. The first coolant exit opening 120 is configured on the contact face 111 in such a manner that said coolant exit opening 120 can supply the inlet opening 213 of the internal coolant guide 210 in the parting blade 200 with coolant. The first coolant exit opening 120 is configured so as to be elongate in the direction from the first end side 101 to the second end side 102 of the clamping block 100. In other words, the first coolant exit opening 120 on the contact face 111 has the form of a slot having an elongate extent that is substantially parallel to the clamping jaws 112, 113. The first coolant exit opening 120 is surrounded by an encircling groove 128 in which, when in use, an elastic sealing element (not illustrated) is received. By virtue of the elongate design of the first coolant exit opening 120, coolant can be reliably transferred to the inlet opening 213 of the parting blade 200 even when the position of the latter relative to the clamping block 100 in the longitudinal direction is varied in a predefined permissible range. An undesirable leakage of coolant is prevented when the parting blade 200 by way of the clamping jaws 112, 113 is tensioned toward the contact face 111 even in the case of high coolant pressures by way of the elastic sealing element that is disposed in the encircling groove 128. As can be seen in the figures, the first coolant exit opening 120 is configured as a reservoir chamber having a cross section that is enlarged in relation to the rest of the first internal coolant duct structure 121 which is configured in the clamping block 100 and will be described in yet more detail hereunder.

A first internal coolant duct structure 121 by way of which the first coolant exit opening 120 while configuring a flow path is connected to a plurality of first coolant entry openings 122, 123, 124 of the clamping block is configured in the clamping block 100. In this way, the first coolant exit opening 120 can be supplied with coolant by way of different coolant entry openings 122, 123, 124, as will be described in more detail hereunder. While the clamping block 100 in the case of the embodiment has a first internal coolant duct structure 121 which is assigned to the first coolant exit opening 120, as well as a second internal coolant duct structure 131 which is assigned to a second coolant exit opening 130, as is schematically illustrated in particular in FIG. 16, only the first internal coolant duct structure 121 is schematically illustrated in FIG. 14 and FIG. 15, and only the second internal coolant duct structure 131 is schematically illustrated in FIG. 10 to FIG. 13 so as to simplify the explanation and improve clarity.

As can be seen in FIG. 5, FIG. 9, and FIG. 14 to FIG. 16, a coolant entry opening 122 of the first coolant entry openings 122, 123, 124 of the clamping block 100 is configured on the second end side 102 of the clamping block 100. This end-side coolant entry opening 122 is configured for connecting a coolant hose and can be closed in a simple manner by means of a screw when said coolant entry opening 122 is not required in the specific installation situation. A further coolant entry opening 123 of the first coolant entry openings 122, 123, 124 is disposed on the lower side 103 of the clamping block 100 in a region that is different from the chucking portion 140, as can be seen in FIG. 5, FIG. 6, and FIG. 14 to FIG. 16. This further coolant entry opening 123 is also configured for connecting a coolant hose and can be closed in a simple manner by means of a screw when said coolant entry opening 123 is not required in the specific installation situation. As can be seen in particular in FIG. 5, FIG. 6, and FIG. 14 to FIG. 16, yet a further coolant entry opening 124 of the plurality of first coolant entry openings 122, 123, 124 is configured on the lower side of the chucking portion 140 which serves for chucking the clamping block 100 on the machine-side mounting 400. In a manner similar to the first coolant exit opening 120, said coolant entry opening 124 is configured so as to be elongate in the direction from the first end side 101 to the second end side 102 of the clamping block 100. The coolant entry opening 124 on the lower side of the chucking portion 140 is surrounded by an encircling groove 125 in which an elastic sealing element (not illustrated) is disposed. The first coolant entry openings 122, 123, and 124 by way of a first internal coolant duct structure 121 in the clamping block 100 that is formed by a plurality of bores are connected so as to communicate with the first coolant exit opening 120. When the clamping block 100 is used in a machine-side mounting in which the contact face 404 for the lower side of the chucking portion 140 is provided with a coolant transfer opening 401 by way of which the coolant can be transferred to the coolant entry opening 124, as is schematically illustrated in FIG. 18 and FIG. 19, this possibility of transferring coolant directly from the machine-side mounting 400 to the clamping block 100 can be utilized by way of the clamping block 100 described, and the two other first coolant entry openings 122 and 123 can be closed. By virtue of the design embodiment of the coolant entry opening 124 as an elongate depression such that an elongate reservoir chamber is configured, the direct transfer of coolant herein can be reliably utilized in the case of different commercially available machine-side mountings 400 in which the coolant transfer openings 401 are of dissimilar design.

When using a machine-side mounting which does not provide any such coolant transfer opening, coolant can be fed to the first coolant exit opening 120 by utilizing one of the two other first coolant entry openings 122, 123, wherein the coolant opening that is in each case not required can be closed. The coolant entry opening 124 on the lower side of the chucking portion 140 is in this case closed in a sealing manner in relation to the machine-side mounting by way of the elastic sealing element that is disposed in the encircling groove 125. The selection of the coolant entry opening to be used herein can be performed flexibly depending on the specific installation situation.

The parting blade 200 that is fastened in the first installation direction on the clamping block 100 can thus be supplied with coolant in flexible manner adapted to the specific installation situation by way of the plurality of the first coolant entry openings 122, 123, 124 which all are connectable to the first coolant exit opening 120 by way of the first internal coolant duct structure 121.

As has already been described above, the clamping block 100 according to the embodiment is also configured for receiving the parting blade 200 in a second installation direction in which the parting blade 200 by way of the active cutter portion 207 projects from the second end side 102 of the clamping block 100.

As can be seen in particular in FIG. 4, FIG. 7, FIG. 10 to FIG. 13, FIG. 16 and FIG. 17, a second coolant exit opening 130 for transferring coolant to the internal coolant guide 210 of the parting blade 200 when the latter is situated in the second installation direction is also provided on the contact face 111. The second coolant exit opening 130 is also configured on the contact face 111 in such a manner that said coolant exit opening 130 can supply the inlet opening 213 of the internal coolant guide 210 in the parting blade 200 with coolant. The second coolant exit opening 130 in terms of the design embodiment thereof is configured like the first coolant exit opening 120, in particular is also surrounded by an encircling groove 138 in which an elastic sealing element (not illustrated) as has been described above is disposed.

The second coolant exit opening 130 by way of a second internal coolant duct structure 131 is connected to a plurality of second coolant entry openings 132, 133, 134 of the clamping block 100, as is schematically illustrated in FIG. 10 to FIG. 13, and FIG. 16. A coolant entry opening 132 of the first coolant entry openings 132, 133, 134 of the clamping block 100 is configured on the first end side 101 of the clamping block 100. This end-side coolant entry opening 132 is configured for connecting a coolant hose and can be closed in a simple manner by means of a screw when said coolant entry opening 132 is not required in the specific installation situation. A further coolant entry opening 133 is disposed on the lower side 103 of the clamping block 100 in a region that is different from the chucking portion 140. This further coolant entry opening 132 is also configured for connecting a coolant hose and can be closed in a simple manner by means of a screw when said coolant entry opening 133 is not required in the specific installation situation. As has also already been described in the context of the first internal coolant duct structure 121, yet a further coolant entry opening 134 is configured on the lower side of the chucking portion 140 which serves for chucking the clamping block 100 on a machine-side mounting 400 also in the case of the second internal coolant structure 131. Said further coolant entry opening 134 is again embodied so as to be elongate and surrounded by an encircling groove 135 in which an elastic sealing element (not illustrated) is received. By virtue of this design embodiment in which the second coolant exit opening 132 is also connected to a plurality of second coolant entry openings 132, 133, 134, the flexible possibilities of infeeding coolant which have already been described above in the context of the first installation direction are thus available also in the case of the parting blade 200 being received in the second installation direction. Furthermore, the clamping block 100 can also be used in a particularly flexible manner for different assembly directions in the different machine-side mountings.

As can be seen from the figures, the first internal coolant duct structure 121 and the second internal coolant duct structure 131 are configured so as to be separate from one another in the clamping block 100. In the case of the embodiment, this is implemented by a disposal of the bores for the first internal coolant duct structure 121 and for the second internal coolant duct structure 131 in such a manner that said bores are configured so as to be mutually offset.

1-15. (canceled)

16. A clamping block for receiving a parting blade having an internal coolant guide, the clamping block comprising:
a parting blade seat having a contact face for contacting a lateral face of the parting blade, said parting blade seat having mutually opposite longitudinal sides;
clamping jaws extending on said opposite longitudinal sides of said contact face for chucking the parting blade on the clamping block;
a first end side of the clamping block from which a cutter portion of the parting blade received by the clamping block projects in a first installation direction;
a second end side of the clamping block, disposed opposite said first end side, from which a cutter portion of the parting blade received by the clamping block projects in a second installation direction;
said contact face having a first coolant exit opening for transferring coolant from the clamping block into the parting blade when installing the parting blade in said first installation direction, and a second coolant exit opening for transferring coolant from the clamping block into the parting blade when installing the parting blade in said second installation direction;
a first internal coolant duct structure configured for connecting said first coolant exit opening to communicate with at least two different first coolant entry openings of the clamping block; and
a second internal coolant duct structure configured for connecting said second coolant exit opening to communicate with at least two different second coolant entry openings of the clamping block.

17. The clamping block according to claim 16, wherein:
said at least two different first coolant entry openings include at least three different first coolant entry openings and said at least two different second coolant entry openings include at least three different second coolant entry openings;
said first internal coolant duct structure is configured to connect said first coolant exit opening to said least three different first coolant entry openings; and
said second internal coolant duct structure is configured to connect said second coolant exit opening to said at least three different second coolant entry openings.

18. The clamping block according to claim 16, wherein said first internal coolant duct structure and said second internal coolant duct structure are separate from one another.

19. The clamping block according to claim 16, wherein said first coolant entry openings include a coolant entry opening on said second end side of the clamping block.

20. The clamping block according to claim 16, wherein said second coolant entry openings include a coolant entry opening on said first end side of the clamping block.

21. The clamping block according to claim 16, which further comprises a lower side of the clamping block, said first coolant entry openings including a coolant entry opening for connecting a coolant hose on said lower side of the clamping block.

22. The clamping block according to claim 16, which further comprises a lower side of the clamping block, said second coolant entry openings including a coolant entry opening for connecting a coolant hose on said lower side of the clamping block.

23. The clamping block according to claim 16, which further comprises:
a chucking portion for chucking in a machine-side mounting for the clamping block, said chucking portion having a lower side; and
said first coolant entry openings including a coolant entry opening on said lower side of said chucking portion for transferring coolant directly from a coolant transfer opening in the machine-side mounting to the clamping block.

24. The clamping block according to claim 16, which further comprises:
a chucking portion for chucking in a machine-side mounting for the clamping block, said chucking portion having a lower side; and
said second coolant entry openings including a coolant entry opening on said lower side of said chucking portion for transferring coolant directly from a coolant transfer opening in the machine-side mounting to the clamping block.

25. The clamping block according to claim 23, wherein said coolant entry opening on said lower side of said chucking portion has an elongate shape.

26. The clamping block according to claim 24, wherein said coolant entry opening on said lower side of said chucking portion has an elongate shape.

27. The clamping block according to claim 25, wherein said coolant entry opening on said lower side of said chucking portion is surrounded by an encircling groove for receiving an elastic sealing element.

28. The clamping block according to claim 26, wherein said coolant entry opening on said lower side of said chucking portion is surrounded by an encircling groove for receiving an elastic sealing element.

29. The clamping block according to claim 16, wherein said first coolant exit opening has an elongate shape.

30. The clamping block according to claim 29, wherein said first coolant exit opening is surrounded by an encircling groove for receiving an elastic sealing element.

31. The clamping block according to claim 16, wherein said second coolant exit opening has an elongate shape.

32. The clamping block according to claim 31, wherein said second coolant exit opening is surrounded by an encircling groove for receiving an elastic sealing element.
